(19) United States
(12) Patent Application Publication
(10) Pub. No.: US 2026/0180022 A1
(43) Pub. Date: Jun. 25, 2026

(54) COMPOSITE ELECTROLYTE, ELECTROLYTE FOR BATTERY, AND BATTERY

(71) Applicants: SUMITOMO CHEMICAL COMPANY, LIMITED, Chuo-ku, Tokyo (JP); Kyoto University, Kyoto-shi, Kyoto (JP)

(72) Inventors: Hideto NAKAJIMA, Niihama-shi, Ehime (JP); Kazuhiko MATSUMOTO, Kyoto-shi, Kyoto (JP); Jinkwang HWANG, Kyoto-shi, Kyoto (JP); Takeru TAKAMI, Kyoto-shi, Kyoto (JP); Rika HAGIWARA, Kyoto-shi, Kyoto (JP)

(21) Appl. No.: 19/126,156

(22) PCT Filed: Nov. 2, 2023
(86) PCT No.: PCT/JP2023/039685

§ 371 Date: Apr. 30, 2025

(30) Foreign Application Priority Data
Nov. 4, 2022 (JP) 2022-177624

(51) Int. Cl. H01M 10/0562; H01M 10/052; H01M 10/0525

(52) U.S. Cl. CPC H01M 10/0562; H01M 10/052; H01M 10/0525

(57) ABSTRACT

A composite electrolyte comprising an inorganic solid electrolyte and a plastic ionic crystal containing an alkali metal ion.

### TECHNICAL FIELD

The present disclosure relates to a composite electrolyte, an electrolyte for a battery, and a battery.

### BACKGROUND ART

Lithium ion batteries have merits of a high operating voltage and a high energy density, and thus are used for various purposes (Patent Literature 1). Recently, a solid electrolyte, which has attracted attention as a novel electrolyte material, is excellent in safety and lithium ion conduction while attention has been paid to problems related to safety of existing electrolytes.

### CITATION LIST

### Patent Literature

Patent Literature 1: WO 2013/136446 A

### SUMMARY OF INVENTION

### Technical Problem

However, the solid electrolyte has poor adhesion with an electrode, and thus has problems that a contact area of an interface is likely to decrease and interface resistance increases. In particular, Li_{6.6}La₃Zr_{1.6}Ta_{0.4}O₁₂ (LLZT), which is an oxide-based solid electrolyte, has high lithium ion conductivity and is expected as an electrolyte of an all-solid-state battery, but has high interface resistance so that the high ion conductivity is not sufficiently utilized in conventional batteries. In addition, grain boundary resistance of a crystal grain boundary inside the solid electrolyte is also large, and it is necessary to overcome these problems.

The present disclosure has been made in view of the above circumstances, and an object thereof is to provide a composite electrolyte capable of reducing interface resistance, and an electrolyte for a battery and a battery including the composite electrolyte.

### Solution to Problem

The present disclosure includes the following embodiments.

[1]

A composite electrolyte including an inorganic solid electrolyte and a plastic ionic crystal containing an alkali metal ion.

[2]

The composite electrolyte according to [1], wherein anions contained in the plastic ionic crystal include an anion having a —SO2- group.

[3]

The composite electrolyte according to [1], wherein at least one of anions contained in the plastic ionic crystal has a —SO₂NSO₂— group or a —SO₃— group.

[4]

The composite electrolyte according to [1], wherein the plastic ionic crystal contains at least one of (FSO₂)₂N⁻ and (CF₃SO₂)₂N⁻.

[5]

The composite electrolyte according to any one of [1] to [4], further including an organic cation,
wherein at least one of anions contained in the plastic ionic crystal has a —SO₂NSO₂— group, and
at least one of following conditions (1) and (2) is satisfied for a Raman spectrum measured at 25° C.:
(1) a Raman shift of a peak corresponding to S—N—S deformation vibration of the anion interacting with the organic cation measured for the composite electrolyte is a higher wavenumber than a Raman shift of a peak corresponding to S—N—S deformation vibration of the anion measured for the plastic ionic crystal which is a salt of the organic cation and the anion contained in the composite electrolyte; and
(2) a Raman shift of a peak corresponding to S—N—S deformation vibration of the anion interacting with the alkali metal ion measured for the composite electrolyte is a higher wavenumber than a Raman shift of a peak corresponding to S—N—S deformation vibration of the anion measured for a salt of the alkali metal ion and the anion contained in the composite electrolyte.
   [6]

The composite electrolyte according to any one of [1] to [5], further including an organic cation,
wherein at least one of anions contained in the plastic ionic crystal has a —SO₂NSO₂— group, and
for a Raman spectrum measured at 25° C., a ratio (Li+/Org+) of an area of a peak corresponding to S—N—S deformation vibration of a group interacting with the alkali metal ion and a group interacting with the organic cation out of the —SO₂— group measured for the composite electrolyte is lower than a ratio (Li+/Org+) of the area measured for the plastic ionic crystal which is a salt of the organic cation and the anion contained in the composite electrolyte.
   [7]

The composite electrolyte according to any one of [1] to [6], wherein the inorganic solid electrolyte contains at least one selected from a group consisting of an oxide-based inorganic electrolyte, a hydride-based solid electrolyte, and a halide-based solid electrolyte.

[8]

The composite electrolyte according to any one of [1] to [7], wherein the inorganic solid electrolyte contains an oxide-based inorganic electrolyte.

[9]

The composite electrolyte according to [8], wherein at least one diffraction peak derived from the oxide-based inorganic solid electrolyte and having a half-value width of 0.18° or less is observed in a range in which 2θ is 20° or less in an X-ray diffraction chart obtained by measuring the composite electrolyte using a CuKα ray at 25° C.

[10]

The composite electrolyte of [8] or [9], wherein
the oxide-based inorganic solid electrolyte includes an acid-treated oxide-based inorganic solid electrolyte, and
at least one half-value width of a diffraction peak in a range in which 2θ is 20° or less, observed for the acid-treated oxide-based inorganic solid electrolyte, is 0.8 times or less a half-value width of a diffraction peak derived from a crystal plane identical to a crystal plane of the diffraction peak and observed for the oxide-based inorganic solid electrolyte before an acid treatment in an X-ray diffraction chart obtained by measurement using a CuKα ray at 25° C. before and after the acid treatment is performed.
   [11]

The composite electrolyte according to any one of [8] to [10], as the oxide-based inorganic solid electrolyte, an oxide-based inorganic solid electrolyte in which at least one diffraction peak having a half-value width of 0.18° or less is observed in a range in which 2θ is 20° or less in an X-ray diffraction chart obtained by measuring the oxide-based inorganic solid electrolyte at 25° C. using a CuKα ray is mixed.

[12]

An electrolyte for a battery, including the composite electrolyte according to any one of [1] to [11].

[13]

A battery including the electrolyte for a battery according to [12].

### Advantageous Effects of Invention

According to the present disclosure, it is possible to provide the composite electrolyte capable of reducing the interface resistance, and the electrolyte for a battery and the battery including the composite electrolyte.

### BRIEF DESCRIPTION OF DRAWINGS

FIG. 1 is a diagram illustrating a Nyquist plot of each sample measured in each measurement cell (A).

FIG. 2 is a diagram illustrating a Nyquist plot measured in each measurement cell (B).

FIG. 3 is a diagram illustrating a Raman spectrum of each sample.

FIG. 4 is a diagram illustrating a Raman spectrum of each sample.

FIG. 5 is a diagram illustrating a Raman spectrum of each sample.

FIG. 6 is diffraction charts illustrating results of a powder X-ray diffraction test of LLZT.

FIG. 7 is a measurement result of LSV measured for Cell 1.

FIG. 8 is a measurement result of LSV measured for Cell 2.

FIG. 9 is a measurement result of LSV measured for Cell 3.

FIG. 10 is a diagram illustrating a result of a cycle test for a cell using a composite electrolyte of Example 2B as an electrolyte.

FIG. 11 is a diagram illustrating a result of a cycle test for a cell using an electrolyte of Example 1A.

### DESCRIPTION OF EMBODIMENTS

A composite electrolyte of the present embodiment contains an inorganic solid electrolyte and a plastic ionic crystal containing an alkali metal ion.

A plastic crystal is a crystal in which chemical species constituting the crystal are arranged in an ordered manner having periodicity, but, in many cases, the chemical species have turbulent motion at certain positions in a grid, and thus the orientation thereof is considered to be disordered. Therefore, it tends to have softer properties than an ionic crystal. Among the plastic crystals, a crystal in which a main component of chemical species constituting the crystal is an ionic species is referred to as a plastic ionic crystal.

The plastic ionic crystal contained in the composite electrolyte of the present embodiment contains alkali metal ions and anions. The alkali metal ions may be any of Li⁺, Na⁺, K⁺, Rb⁺ and Cs⁺, and may contain at least one of Li⁺, Na⁺ and K⁺, may contain at least one of Li⁺ and Na⁺, or may contain Li.

Among the alkali metal ions contained in the composite electrolyte, the proportion of one alkali metal ion may be 80% by mol or more, 90% by mol or more, or 95% by mol or more. The one alkali metal ion may be at least one of Li⁺, Na⁺ and K⁺, may be at least one of Li⁺ and Na⁺, or may be Li⁺.

Examples of the anions contained in the plastic ionic crystal include anions having F⁻, Cl⁻, Br⁻, I⁻, ClO₄⁻, PF₆⁻, BF₄⁻, and a —SO₂— group. The anions may include an anion having a —SO₂— group. The plastic ionic crystal may contain one or a plurality of the anions.

Examples of the anion having the —SO₂— group include anions having SO₄²⁻, HSO₃⁻, and a —SO₂NSO₂— group, and an anion having a —SO₃— group. Examples of the anion having a —SO₂NSO₂— group include [(CₕF₂ₕ₊₁)SO₂]₂N⁻ (h is 0 to 3) and [(CₕF₂ₕ₊₁)SO₂]N⁻[(CᵢF₂ᵢ₊₁)SO₂] (h and i are 0 to 3), and specifically include (FSO₂)₂N⁻ (bis(fluorosulfonyl)amide ion, hereinafter also referred to as FSA ion) and (CF₃SO₂)₂N⁻ (bis(trifluoromethylsulfonyl)amide ion, also referred to as TFSA ion). Examples of the anion having the —SO₃— group include [(CₕF₂ₕ₊₁)SO₃]⁻ (h is 0 to 3), and specifically include FSO₃⁻ and CF₃SO₃⁻. The plastic ionic crystal may contain at least one anion selected from the group consisting of [(CₕF₂ₕ₊₁)SO₂]₂N⁻, [(CₕF₂ₕ₊₁)SO₂]N⁻(CᵢF₂ᵢ₊₁)SO₂], and [(CₕF₂ₕ₊₁)SO₃]⁻, may contain at least one anion selected from the group consisting of (FSO₂)₂N⁻, (CF₃SO₂)₂N⁻, FSO₃⁻, and CF₃SO₃⁻, and may contain at least one of (FSO₂)₂N⁻ and (CF₃SO₂)₂N⁻.

The plastic ionic crystal may contain a cation other than alkali metal ions. Examples of such a cation include an organic cation. The organic cation may be a cation containing a nitrogen atom having a positive formal charge (for example, +monovalent). The organic cation may contain at least one selected from the group consisting of an imidazolium cation, a pyrrolidinium cation, a piperidinium cation, a pyridinium cation, a quaternary ammonium cation, and a quaternary phosphonium cation, and may contain a pyrrolidinium cation. The plastic ionic crystal may contain one or a plurality of the organic cations. Examples of the pyrrolidinium cation include an N-ethyl-N-methylpyrrolidinium cation.

The plastic ionic crystal can be obtained, for example, by mixing an alkali metal salt (which may be crystalline) with another plastic ionic crystal. Examples of the alkali metal salt include MF, MCl, MBr, MI, MClO₄, MPF₆, MBF₄, M₂SO₄, M[(CₕF₂ₕ₊₁)SO₃](h is 0 to 3), M[(CₕF₂ₕ₊₁)SO₂]₂N (h is 0 to 3), and M[(CₕF₂ₕ₊₁)SO₂]N⁻[(CᵢF₂ᵢ₊₁)SO₂] (h, i is 0 to 3), where M is the alkali metal. One or a plurality of the alkali metal salts may be used.

The other plastic ionic crystal is not particularly limited, and examples thereof include plastic crystals containing no alkali metal ion, and specifically include an imidazolium salt, a pyrrolidinium salt, a piperidinium salt, a pyridinium salt, a quaternary ammonium salt, and a quaternary phosphonium salt. One or a plurality of the other plastic ionic crystals may be used. Examples of an anion contained in the other plastic ionic crystal include those exemplified as the anion contained in the plastic ionic crystal of the present embodiment.

### <Inorganic Solid Electrolyte>

The inorganic solid electrolyte is not particularly limited, and may be an oxide (oxide-based inorganic solid electrolyte), a sulfide (sulfide-based solid electrolyte), a hydride (hydride-based solid electrolyte), a halide (halide-based solid electrolyte), or the like. The inorganic solid electrolyte may contain at least one of an alkali metal element and an alkaline earth metal element, and may contain an alkali metal element.

### (Oxide-Based Inorganic Solid Electrolyte)

Examples of the oxide-based inorganic solid electrolyte include an oxide such as a perovskite-type oxide, a NASICON-type oxide, a LISICON-type oxide, or a garnet-type oxide, and those obtained by doping the oxide with other cations or anions.

Examples of the perovskite-type oxide include a Li—La—Ti-based oxide such as LiₐLa₁₋ₐTiO₃ (0<a<1), a Li—La—Ta-based oxide such as Li_{b}La_{1-b}TaO₃ (0<b<1), and a Li—La—Nb-based oxide such as Li_{c}La_{1-c}NbO₃ (0<c<1).

Examples of the NASICON-type oxide include Li_{1+d}Al_{d}Ti_{2-d}(PO₄)₃ (0≤d≤1). The NASICON-type oxide is an oxide represented by LiₘM¹ₙM²ₒPₚO_{q} (in the formula, M¹ is one or more elements selected from the group consisting of B, Al, Ga, In, C, Si, Ge, Sn, Sb, and Se, M² is one or more elements selected from the group consisting of Ti, Zr, Ge, In, Ga, Sn, and Al, and m, n, o, p, and q are arbitrary positive numbers), and examples thereof include Li_{1+x+y}Alₓ(Ti,Ge)₂₋ₓSi_{y}P_{3-y}O₁₂ (0<x<2, 0<y<3) (LATP).

Examples of the LISICON-type oxide include an oxide represented by Li₄M³O₄—Li₃M⁴O₄ (M³ is one or more elements selected from the group consisting of Si, Ge, and Ti, and M⁴ is one or more elements selected from the group consisting of P, As, and V).

Examples of the garnet-type oxide include a Li—La—Zr-based oxide such as Li₇La₃Zr₂O₁₂ (LLZ) or Li₇₋ₐ₂La₃Zr₂₋ₐ₂Taₐ₂O₁₂ (LLZT, 0<a2<1, 0.1<a2<0.8, 0.2<a2<0.6).

The oxide-based inorganic solid electrolyte may be a crystalline material or an amorphous material.

Examples of the oxide-based inorganic solid electrolyte include Li_{6.6}La₃Zr_{1.6}Ta_{0.4}O₁₂ and Li_{0.33}La_{0.55}TiO₃.

### (Sulfide-Based Solid Electrolyte)

Examples of the sulfide-based solid electrolyte include a Li₂S—P₂S₅-based compound, a Li₂S—SiS₂-based compound, a Li₂S—GeS₂-based compound, a Li₂S—B₂S₃-based compound, a Li₂S—P₂S₃-based compound, LiI—Si₂S—P₂S₅, LiI—Li₂S—P₂O₅, LiI—Li₃PO₄—P₂S₅, and Li₁₀GeP₂S₁₂.

A content of the plastic ionic crystal with respect to a total of the inorganic solid electrolyte and the plastic ionic crystal in the composite electrolyte may be 7 to 70% by mass or 10% to 60% by mass.

A content of the inorganic solid electrolyte with respect to the total of the inorganic solid electrolyte and the plastic ionic crystal in the composite electrolyte may be 30% to 93% by mass or 40% to 90% by mass.

A molar ratio of the alkali metal ion to the anion in the plastic ionic crystal contained in the composite electrolyte is not particularly limited, and may be 1% to 95% by mol. The molar ratio of the alkali metal ion to the other cation in the plastic ionic crystal contained in the composite electrolyte is not particularly limited, and may be 1% to 1900% by mol or 5% to 1000% by mol.

The composite electrolyte may contain, as the inorganic solid electrolyte, at least one selected from the group consisting of an oxide-based inorganic solid electrolyte, a hydride-based solid electrolyte, and a halide-based solid electrolyte, and may contain an oxide-based inorganic solid electrolyte.

The composite electrolyte may contain, as the oxide-based inorganic solid electrolyte, an oxide-based inorganic solid electrolyte in which at least one diffraction peak having a half-value width of 0.18° or less is observed in a range in which 2θ is 20° or less in an X-ray diffraction chart obtained by measurement using CuKα rays at 25° C. The diffraction peak having the half-value width of 0.18° or less, derived from the oxide-based inorganic solid electrolyte, may be observed in a state of being contained in the composite electrolyte, or may be observed before being mixed in the composite electrolyte. Such an oxide-based inorganic solid electrolyte can be obtained by performing an acid treatment on the oxide-based inorganic solid electrolyte in advance. Examples of acid used for the acid treatment include acids such as hydrochloric acid, sulfuric acid, and nitric acid. The concentration of the acid is not particularly limited, but it is more preferable to perform a treatment at a high concentration for a short time (for example, for 10 to 60 seconds).

In addition, the oxide-based inorganic solid electrolyte may contain an oxide-based inorganic solid electrolyte satisfying the following conditions. That is, in the X-ray diffraction chart obtained by the measurement using CuKα rays at 25° C. before and after the acid treatment is performed, at least one half-value width of a diffraction peak in the range in which 2θ is 20° or less, observed for the acid-treated oxide-based inorganic solid electrolyte, may be 0.8 times or less a half-value width of a diffraction peak derived from a crystal plane identical to a crystal plane of the diffraction peak and observed for the oxide-based inorganic solid electrolyte before the acid treatment. The diffraction peak derived from the oxide-based inorganic solid electrolyte after the acid treatment may be observed in a state of being contained in the composite electrolyte, or may be observed before being mixed in the composite electrolyte.

When the composite electrolyte further contains the organic cation and at least one of the anions contained in the plastic ionic crystal has a —SO₂NSO₂— group, the composite electrolyte may satisfy at least one of the following conditions (1) and (2) regarding a Raman spectrum measured for the composite electrolyte at 25° C.
(1) A Raman shift of a peak corresponding to S—N—S deformation vibration of an anion interacting with the organic cation measured for the composite electrolyte is a higher wavenumber than a Raman shift of a peak corresponding to S—N—S deformation vibration of an anion measured for the plastic ionic crystal which is a salt of the organic cation and the anion contained in the composite electrolyte. A difference in the Raman shift between the peak corresponding to the S—N—S deformation vibration of the composite electrolyte and the peak corresponding to the S—N—S deformation vibration of the plastic crystal may be 0.5 to 20 cm⁻¹, 1 to 10 cm⁻¹, or 1 to 5 cm⁻¹. In addition, the difference in the Raman shift may be 0.5 to 10 cm⁻¹, 0.5 to 5 cm⁻¹, or 1 to 5 cm⁻¹.
(2) A Raman shift of a peak corresponding to S—N—S deformation vibration of an anion interacting with the alkali metal ion measured for the composite electrolyte is a higher wavenumber than a Raman shift of a peak corresponding to S—N—S deformation vibration of an anion measured for a salt of the alkali metal ion and the anion contained in the composite electrolyte. A difference in the Raman shift between the peak corresponding to the S—N—S deformation vibration of the composite electrolyte and the peak corresponding to the S—N—S deformation vibration of the salt of the alkali metal ion and the anion may be 0.05 to 20 cm⁻¹, 0.1 to 20 cm⁻¹, 0.5 to 20 cm⁻¹, 1 to 10 cm⁻¹, or 1 to 5 cm⁻¹. In addition, the difference in the Raman shift may be 0.05 to 10 cm⁻¹ or 0.1 to 5 cm⁻¹.

Regarding (1), the plastic ionic crystal, which is the salt of the organic cation and the anion contained in the composite electrolyte, may contain all the organic cations and anions contained in the composite electrolyte.

Regarding (2), the salt of the alkali metal ion and the anion contained in the composite electrolyte may contain all the alkali metal ions and anions contained in the composite electrolyte.

It is known that a peak position of a peak corresponding to S—N—S deformation vibration in the Raman spectrum of the anion having the —SO₂NSO₂— group varies depending on an interacting cation. That is, it is known that a low wavenumber-side peak of the Raman spectrum belongs to the anion interacting with the organic cation, and a high wavenumber-side peak belongs to the anion interacting with the alkali metal ion.

When the composite electrolyte contains the anion having the —SO₂NSO₂— group, and the organic cation, for the Raman spectrum measured at 25° C., a ratio (Li+/Org+) of the area of a peak corresponding to S—N—S deformation vibration between a group interacting with the alkali metal ion and a group interacting with the organic cation in the —SO₂NSO₂— group measured for the composite electrolyte may be lower than a ratio (Li+/Org+) of the area measured for the plastic ionic crystal which is the salt of the organic cation and the anion contained in the composite electrolyte.

The composite electrolyte of the present embodiment can be used, for example, as a material for electrochemical devices such as a capacitor and a battery. Examples of such a material include a material of an electrolyte for a battery (solid electrolyte) which is an electrolyte as a member of the battery. Examples of the battery include batteries such as a lithium ion battery and a sodium ion battery, which are charged and discharged by movement of alkali metal ions between a positive electrode and a negative electrode. In addition, the composite electrolyte of the present embodiment can be used as an ion conductive material, and may be contained in the positive electrode or the negative electrode of the battery.

The composite electrolyte of the present embodiment may be contained in a composition (electrolyte composition) for forming the electrolyte for a battery (solid electrolyte). The electrolyte composition may contain a conductive additive in addition to the composite electrolyte. The conductive additive is not particularly limited, and examples thereof include carbon materials, and specific examples of the carbon materials include: graphites such as natural graphite (flake graphite and the like) and artificial graphite; carbon blacks such as acetylene black, Ketjen black, channel black, furnace black, lamp black, and thermal black; and carbon fibers. A content of the conductive additive in the electrolyte composition may be 10:3 to 10:0.1 or 10:2.5 to 10:0.5 in a mass ratio of the composite electrolyte to the conductive additive.

Hereinafter, the battery of the present embodiment will be described using a lithium ion battery as an example. The lithium ion battery includes a positive electrode, a negative electrode, and an electrolyte (solid electrolyte) disposed between the positive electrode and the negative electrode. The composite electrolyte of the present embodiment may be contained in the electrolyte of the lithium ion battery.

The positive electrode of the lithium ion battery is not particularly limited and contains a positive electrode active material, and may contain a conductive additive, a binder, and the like as necessary.

The positive electrode may have a configuration in which a layer that contains these materials is formed on a current collector. Examples of the positive electrode active material include a lithium-containing composite metal oxide containing lithium (Li) and at least one transition metal selected from the group consisting of V, Cr, Mn, Fe, Co, Ni, and Cu. Examples of such a lithium composite metal oxide include LiCoO₂, LiNiO₂, LiMn₂O₄, Li₂MnO₃, LiNiₓMn_{y}Co_{1-x-y}O₂ [0<x+y<1], LiNiₓCo_{y}Al_{1-x-y}O₂ [0<x+y<1], LiCr_{0.5}Mn_{0.5}O₂, LiFePO₄, Li₂FeP₂O₇, LiMnPO₄, LiFeBO₃, Li₃V₂(PO₄)₃, Li₂CuO₂, Li₂FeSiO₄, and Li₂MnSiO₄.

The negative electrode of the lithium ion battery is not particularly limited and contains a negative electrode active material, and may contain a conductive additive, a binder, and the like as necessary. Examples thereof include single elements such as Li, Si, P, Sn, Si—Mn, Si—Co, Si—Ni, In, and Au, as well as alloys or composites containing these elements, carbon materials such as graphite, and substances in which lithium ions are intercalated between layers of the carbon materials.

The material of the current collector is not particularly limited, and may be a single metal element such as Cu, Mg, Ti, Fe, Co, Ni, Zn, Al, Ge, In, Au, Pt, Ag, or Pd, or an alloy.

A solid electrolyte layer may include a plurality of layers. For example, in addition to the solid electrolyte layer containing the composite electrolyte of the present embodiment, a sulfide solid electrolyte layer may be included. The sulfide solid electrolyte layer may be included between the solid electrolyte containing the composite electrolyte of the present embodiment and the negative electrode. The sulfide solid electrolyte is not particularly limited, and examples thereof include Li₆PS₅Cl, Li₂S—PS₅, Li₁₀GeP₂S₁₂, Li_{9.6}P₃S₁₂, Li_{9.54}Si_{1.74}P_{1.44}S_{11.7}Cl_{0.3}, and Li₃PS₄.

### EXAMPLES

### (Production of Plastic Ionic Crystal)

### Production Example 1

Lithium bis(trifluoromethylsulfonyl)amide (LiTFSA, manufactured by Kishida Chemical Co., Ltd.) and a plastic ionic crystal [C2C1pyrr] [TFSA] (N-ethyl-N-methylpyrrolidinium bis(trifluoromethylsulfonyl)amide, manufactured by KANTO CHEMICAL CO., INC.) were mixed at a substance amount ratio of 5:95 to obtain a mixture. Acetonitrile was added to the obtained mixture to form a homogeneous solution, and the acetonitrile was removed under vacuum to obtain homogeneous plastic crystals (hereinafter, also referred to as a plastic ionic crystal 1 (IPC 1)).

### Production Example 2

A plastic ionic crystal 2 (IPC 2) was obtained in the same manner as in Production Example 1 except that lithium bis(fluorosulfonyl)amide (LiFSA, manufactured by Kishida Chemical Co., Ltd.) and plastic ionic crystal [C2C1pyrr] [FSA] (manufactured by KANTO CHEMICAL CO., INC.) were mixed at a substance amount ratio of 5:95.

### Production Example 3

A plastic ionic crystal 3 (IPC 3) was obtained in the same manner as in Production Example 1 except that lithium bis(fluorosulfonyl)amide (LiFSA, manufactured by Kishida Chemical Co., Ltd.) and plastic ionic crystal [C2C1pyrr] [FSA] (manufactured by KANTO CHEMICAL CO., INC.) were mixed at a substance amount ratio of 90:10.

### (Preparation of Inorganic Solid Electrolyte)

LLZT pellets (manufactured by Toshima Manufacturing Co., Ltd.) were prepared as an inorganic solid electrolyte. The inorganic solid electrolyte was immersed in 36% by mass of hydrochloric acid for 30 seconds or 5 minutes. Samples before the acid treatment, after the acid treatment for 30 seconds, and after the acid treatment for 5 minutes were subjected to a powder X-ray diffraction test at 25° C. Test conditions are as follows.
Measuring apparatus: SmalrtLab (manufactured by Rigaku Holdings Corporation)
X-ray generator: CuKα radiation source, voltage 40 kV, current 30 mA
X-ray detector: Silicon strip high-speed detector
Measurement range: Diffraction angle 2θ=10° to 70°
Scan speed: 1°/min

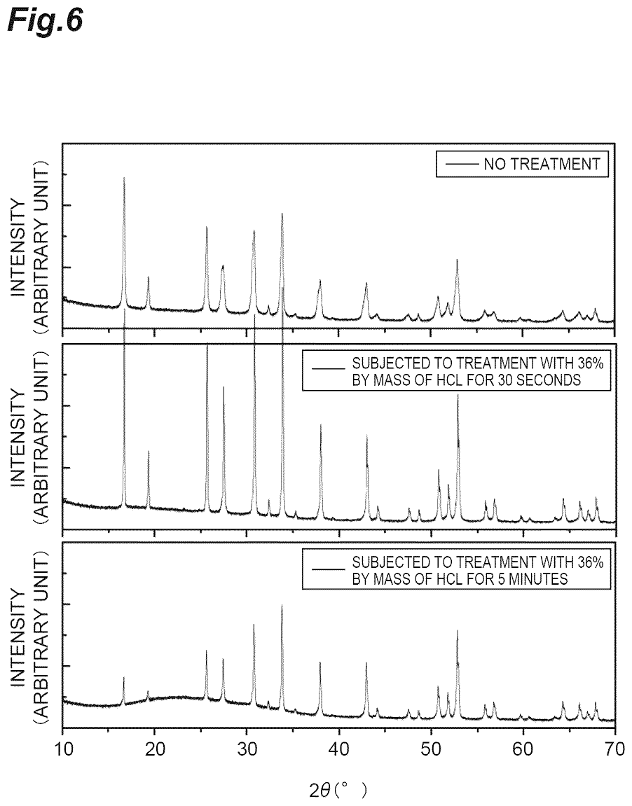

FIG. 6 is diffraction charts illustrating results of the powder X-ray diffraction test. In FIG. 6, three diffraction charts are measurement results of the samples before the acid treatment, after the acid treatment for 30 seconds, and after the acid treatment for 5 minutes, respectively, in order from the top. A half-value width (full width at half maximum) of a peak at 2θ of 16.7° was 0.1961° before the acid treatment, but was 0.0745° (about 0.38 times) after the treatment with 36% by mass of hydrochloric acid for 30 seconds. In addition, a half-value width (full width at half maximum) of a peak at 2θ of 19.3° was 0.1967° before the acid treatment, but was 0.0937° (about 0.48 times) after the treatment with 36% by mass of hydrochloric acid for 30 seconds. An oxide coating is formed on the surface of LLZT powder, but the oxide coating is removed by the acid treatment. As a result, crystallinity is improved, and a half-value width of a diffraction peak after the acid treatment for 30 seconds is smaller than that before the acid treatment. However, when the time of the acid treatment is extended to 5 minutes, a reaction between LLZT and hydrochloric acid proceeds, and conversely, the crystallinity is lost. Therefore, hereinafter, the pellets and powder both treated with 2% by mass of hydrochloric acid for 30 seconds were used as the inorganic solid electrolyte.

### Example 1A

The IPC 1 and the inorganic solid electrolyte were mixed in a mortar, and pressure-bonded (300 MPa) by a press machine to prepare a pellet-shaped composite electrolyte.

### Example 2A

A composite electrolyte was prepared in the same manner as in Example 1A except that a mixing ratio of the LLZT powder and the IPC 1 was changed as shown in Table 1.

### Comparative Examples 1A to 3A

As shown in Table 1, a sample of each of Comparative Examples was prepared. Note that, for the sample of Comparative Example 1A, the LLZT powder was pressure-bonded (300 MPa) by a press machine to prepare a pellet-shaped LLZT electrolyte.

### <Measurement of Hardness>

For each of samples of Examples and Comparative Examples, hardness was measured using an A-type hardness tester based on JIS K 6253. As the samples, pellets having a diameter of 8 mm were used. The hardness was measured at five points of each of the samples of Examples and Comparative Examples, and an average value thereof was taken.

TABLE 1

| | Composition* | Hardness |
|---|---|---|
| Example 1A | IPC1:LLZT = 10:90 | 84.8 |
| Example 2A | IPC1:LLZT = 30:70 | 87.8 |
| Comparative | LLZT 100% | >95 |
| Example 1A | | |
| Comparative | [C2C1pyrr] [TFSA] 100% | Broken |
| Example 2A | | |
| Comparative | IPC1 | Broken |
| Example 3A | | |

*Mass ratio

In Table 1, the sample of Comparative Example 1 had high strength, but depending on a measurement position, the sample was sometimes broken during the measurement so that the hardness could not be measured. In Comparative Example 2A and Comparative Example 3A, the samples were broken during the measurement at all the points, and the measurement was impossible. It is presumed that particles of the inorganic solid electrolyte were more strongly bound to each other by mixing the plastic ionic crystal in the inorganic solid electrolyte so that the sample was less likely to crack.

### Examples 1B to 2B

Composite electrolytes were prepared in the same manner as in Example 1 except that the IPC 2 was used instead of the IPC 1 and each composition shown in Table 2 was used.

### Examples 3B to 4B

Composite electrolytes were prepared in the same manner as in Example 1 except that the IPC 3 was used instead of the IPC 1 and each composition shown in Table 2 was used.

### Comparative Example 4B

A composite electrolyte was prepared in the same manner as in Example 1 except that 1-ethyl-3 methylimidazolium bis(fluorosulfonyl)amide ([C2C1im] [FSA]), which is an ionic liquid, was used instead of the IPC 1, and composition shown in Table 2 was used.

For the composite electrolytes of Examples 1B to 4B and Comparative Example 4B, hardness was measured using the A-type hardness tester as described above. Results are shown in Table 2.

TABLE 2

| | Composition* | Hardness |
|---|---|---|
| Example 1B | IPC2:LLZT = 10:90 | 80.4 |
| Example 2B | IPC2:LLZT = 30:70 | 79.8 |
| Example 3B | IPC3:LLZT = 10:90 | 85.4 |
| Example 4B | IPC3:LLZT = 30:70 | 89.2 |
| Comparative | IL:LLZT = 20:80 | Broken |
| Example 4B | | |

*Mass ratio

### <Measurement of Impedance>

The sample of Comparative Example 1A and the composite electrolytes of Example 1A and Example 2A were each sandwiched between two Li plates to prepare measurement cells (A). In addition, the sample of Comparative Example 1A, the composite electrolytes of Example 1A and Example 2A were each sandwiched between two SUS (SUS316L) plates to prepare measurement cells (B).

The two Li plates of each of the measurement cells (A) were electrically connected to terminals of an impedance analyzer (Sl 1260 manufactured by Solatron Analytical), and an AC impedance spectrum was measured. The measurement was performed at 25° C. in a frequency range of 10 mHz to 10 MHz. Similarly, the measurement was performed for each of the measurement cells (B). The obtained resistance values are shown in Table 3.

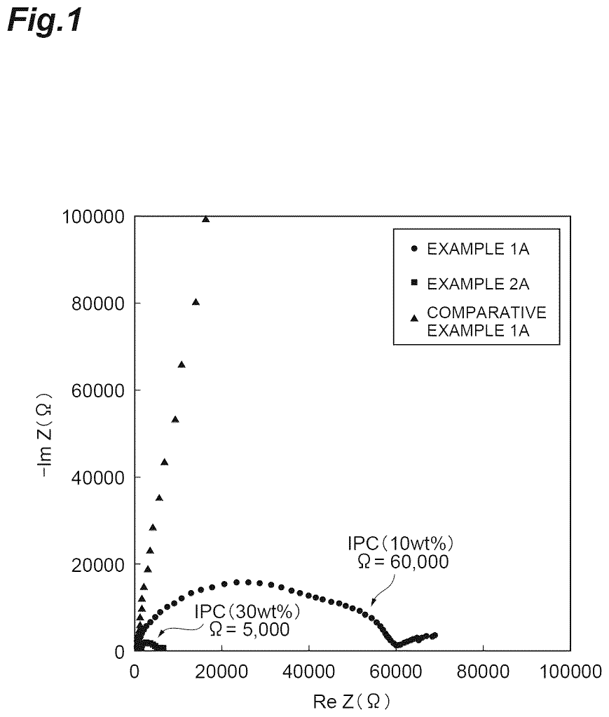

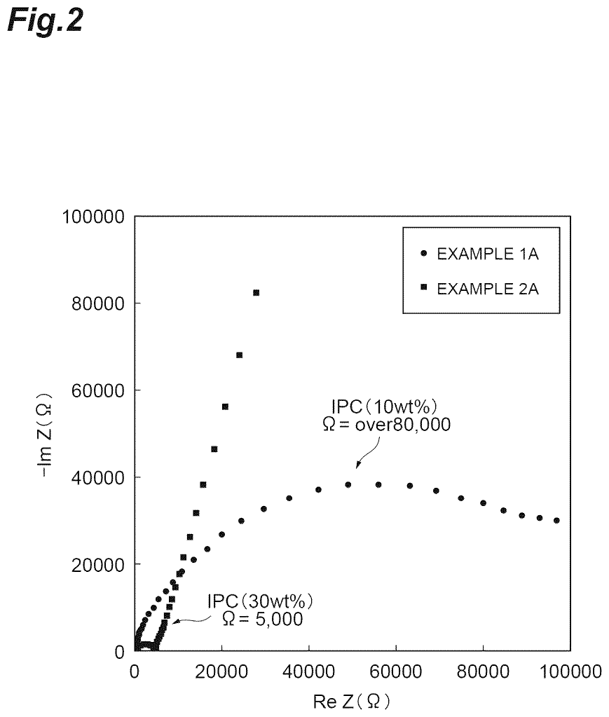

FIG. 1 is a diagram illustrating Nyquist plots measured in the respective measurement cells (A). In addition, FIG. 2 is a diagram illustrating Nyquist plots measured in the respective measurement cells (B).

TABLE 3

| | Measurement cell | Measurement cell |
|---|---|---|
| | (A) | (B) |
| Example 1A | 60000 Ω | <80000 Ω |
| Example 1B | 5000 Ω | 5000 Ω |
| Comparative | Immeasurable* | Immeasurable* |
| Example 1A | | |

*Resistance was too high so that measurement was impossible.

As can be seen from Table 3, in the composite electrolytes of Example 1A and Example 2A, adhesion of an interface was improved, and interface resistance decreased.

### <Measurement of Raman Spectrum>

A Raman spectrum was measured using a Raman spectrometer (DRX3 manufactured by Thermo Fisher Scientific). The measurement was performed by putting each of the samples into a sealable glass bottle and irradiating the pellets with a laser (wavelength: 785 nm).

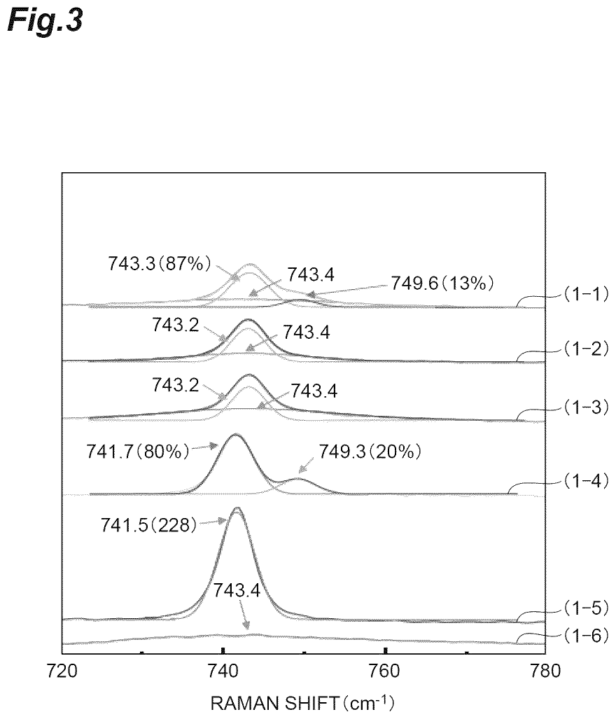

The Raman spectrum of each sample is illustrated in FIG. 3. Six Raman spectra in FIG. 3 correspond to the following samples, respectively, in order from the top. Note that the ordinate in FIGS. 3 to 5 represents intensity (arbitrary unit).
(1-1) Composite electrolyte of Example 2A
(1-2) A mixture of LLZT and [C2C1pyrr] [TFSA] at 70:30 (mass ratio)
(1-3) Composite electrolyte of Example 1A
(1-4) IPC 1
(1-5) [C2C1pyrr] [TFSA]
(1-6) LLZT

The spectra of (1-1) to (1-6) in FIG. 3 were subjected to curve fitting to separate peaks. In addition, peak positions of the separated peaks can be compared to be attributed as follows.

(1-1)
S—N—S deformation vibration of TFSA anion interacting with organic cation (743.3 cm⁻¹)
S—N—S deformation vibration of TFSA anion interacting with alkali metal ion (749.6 cm⁻¹)
Peak of LLZT (743.4 cm⁻¹)
   (1-2)
S—N—S deformation vibration of TFSA anion interacting with organic cation (743.2 cm⁻¹)
Peak of LLZT (743.4 cm⁻¹)
   (1-3)
S—N—S deformation vibration of TFSA anion interacting with organic cation (743.2 cm⁻¹)
Peak of LLZT (743.4 cm⁻¹)
   (1-4)
S—N—S deformation vibration of TFSA anion interacting with organic cation (741.7 cm⁻¹)
S—N—S deformation vibration of TFSA anion interacting with alkali metal ion (749.3 cm⁻¹)
   (1-5)
S—N—S deformation vibration of TFSA anion interacting with organic cation (741.5 cm⁻¹)
   (1-6)
Peak of LLZT (743.4 cm⁻¹)

In the spectrum of (1-5) in FIG. 3, a peak corresponding to the S—N—S deformation vibration of the TFSA anion interacting with the organic cation is seen at 741.5 cm⁻¹. In addition, in the spectrum of (1-4) in FIG. 3, a peak corresponding to the S—N—S deformation vibration of the TFSA anion interacting with the organic cation is observed at 741.7 cm⁻¹, which is substantially the same position as that of (1-5), and a peak corresponding to the S—N—S deformation vibration of the TFSA anion interacting with a lithium ion is observed at 749.3 cm⁻¹. On the other hand, in the spectra of (1-1), (1-2), and (1-3) containing LLZT, the peak corresponding to the S—N—S deformation vibration of the TFSA anion interacting with the organic cation is shifted to around 743.2 cm⁻¹. This suggests that the interaction between the TFSA anion and LLZT also occurs. Note that the peak in the Raman spectrum of LLZT is extremely broad as illustrated in (1-6), and thus can be clearly distinguished from the peaks corresponding to the S—N—S deformation vibration of the TFSA anions.

In the spectrum of (1-4), a ratio of the area (Li+) of the peak attributed to the S—N—S deformation vibration (749.3 cm⁻¹) of the TFSA anion interacting with the alkali metal ion to the area (Org+) of the peak attributed to the S—N—S deformation vibration (741.7 cm⁻¹) of the TFSA anion interacting with the organic cation is (20/80)=0.25. On the other hand, in the spectrum of (1-4), a ratio of the area (Li+) of the peak attributed to the S—N—S deformation vibration (749.6 cm⁻¹) of the TFSA anion interacting with the alkali metal ion to the area (Org+) of the peak attributed to the S—N—S deformation vibration (743.3 cm⁻¹) of the TFSA anion interacting with the organic cation is (13/87)=0.15. When LLZT is added to the IPC in this manner, the area of the peak attributed to LiTFSI relatively decreases. In the spectrum of (1-2), the peak attributed to the S—N—S deformation vibration (749.3 cm⁻¹) of the TFSA anion interacting with the alkali metal ion almost disappeared. It is found that the interaction between Li+ and the TFSI anion is weakened. As a result, it is found that Li⁺ easily moves.

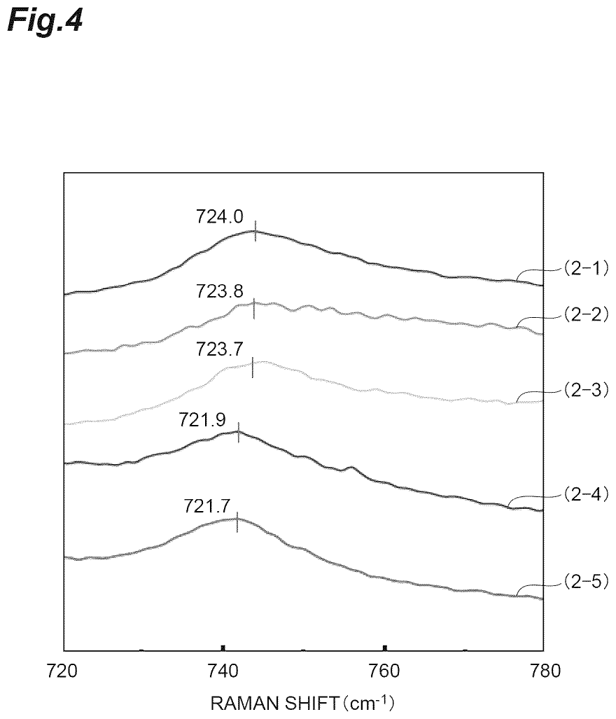

The Raman spectrum of each sample is illustrated in FIG. 4. Five Raman spectra in FIG. 4 correspond to the following samples, respectively, in order from the top.
(2-1) Composite electrolyte of Example 1B
(2-2) Composite electrolyte of Example 2B
(2-3) A mixture of [C2C1pyrr] [FSA] and LLZT at 30:70 (mass ratio)
(2-4) IPC 2
(2-5) [C2C1pyrr] [FSA]

From the results illustrated in FIG. 4, a shift to a higher wavenumber of the S—N—S deformation vibration of the FSA anion interacting with the organic cation was also observed similarly when the FSA anion was used as the anion in the case of mixing LLZT.

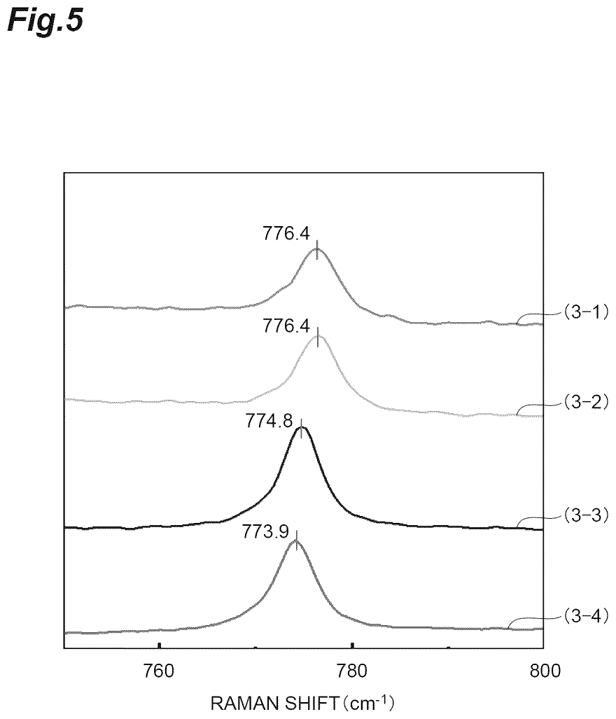

In addition, the Raman spectrum of each sample is illustrated in FIG. 5. Four Raman spectra in FIG. 5 correspond to the following samples in order from the top.
(3-1) Composite electrolyte of Example 3B
(3-2) Composite electrolyte of Example 4B
(3-3) IPC 3
(3-4) Li [FSA]

From the results illustrated in FIG. 5, a shift to a higher wavenumber of the S—N—S deformation vibration of the FSA anion interacting with the alkali metal ion was also observed similarly when the FSA anion was used as the anion in the case of mixing LLZT.

### <Oxidation Resistance Test (Linear Sweep Voltammetry (LSV))>

Linear sweep voltammetry measurement was performed on three cells (two-electrode cells) having the following configurations.
Cell 1: (Lithium/Electrolyte 11/Aluminum mesh)
Cell 2: (Lithium/Electrolyte 21/Electrolyte 22/Aluminum mesh)
Cell 3: (Lithium/Electrolyte 31/Electrolyte 32/Aluminum mesh)

Note that the composition of each electrolyte is as follows.

Electrolyte 11: Mixture of LLZT and acetylene black (AB) at mass ratio of 10:2 being impregnated with 1 M of LiPF₆ solution (using, as solvent, mixed solvent of ethylene carbonate (EC):dimethyl carbonate (DMC)=1:1 (volume ratio))
Electrolyte 21: Composite electrolyte of Example 2B
Electrolyte 22: Mixture of IPC 2 and acetylene black at mass ratio of 7:3
Electrolyte 31: Composite electrolyte of Example 2B
Electrolyte 32: Mixture of composite electrolyte of Example 2B and acetylene black at mass ratio of 10:2

The LSV measurement was performed using VPS manufactured by BioLogic. Conditions for the LSV measurement were a scan rate: 0.1 mV/s, an electrolyte pellet area: 0.79 cm², and an electrode area: 0.50 cm² (each area is the area perpendicular to a voltage application direction). Note that a working electrode potential is represented on the basis of Li/Li⁺.

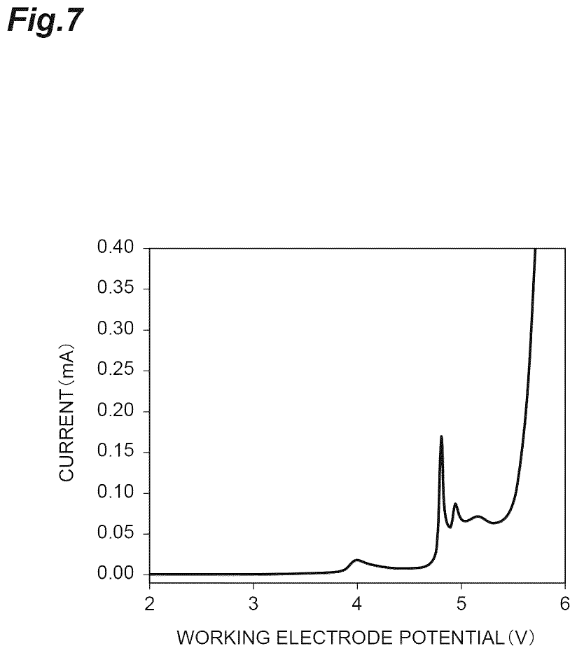

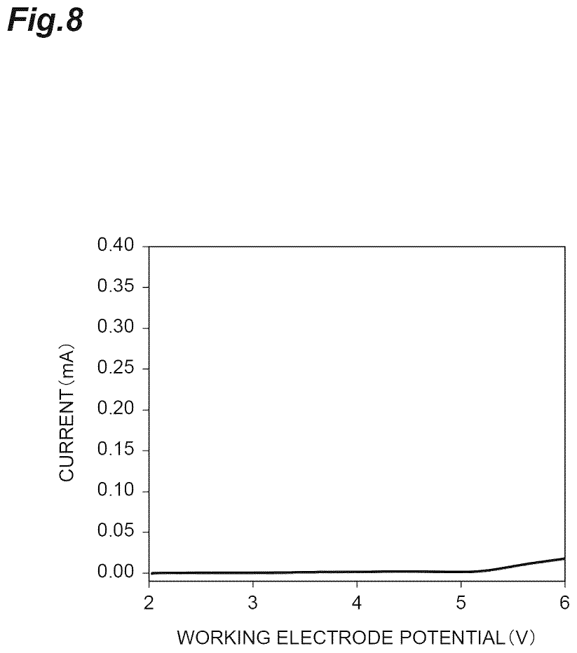

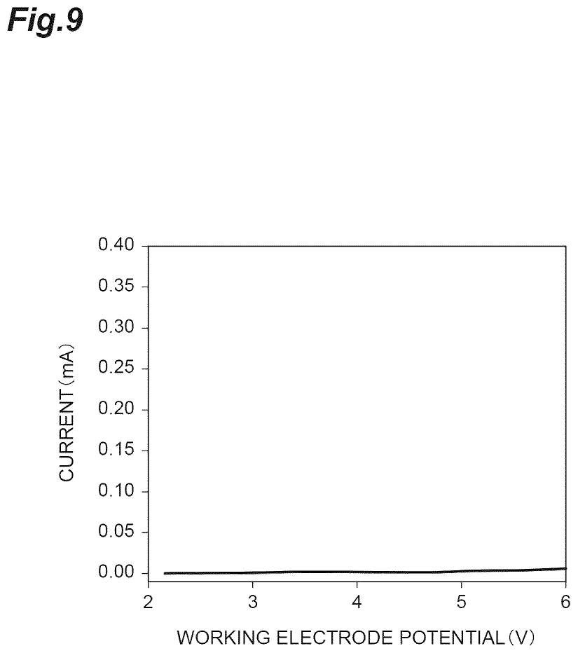

FIGS. 7 to 9 illustrate measurement results of the LSV measured for each of Cells 1 to 3. As illustrated in FIG. 7, in Cell 1 not using the IPC, an oxidation peak is observed around 4 V. On the other hand, as illustrated in FIG. 8, in Cell 2 using the IPC 2 electrolyte, an oxidation current was not observed up to around 5.2 V. In addition, as illustrated in FIG. 9, in Cell 3 using the composite electrolyte of Example 2B and acetylene black, an oxidation current was not observed. From this, it is considered that oxidative decomposition of LLZT is suppressed by using the IPC and LLZT in combination.

### (Cycle Test)

An evaluation cell of a coin-type battery CR2032 was assembled in a dry argon atmosphere in a glove box. Specifically, the respective layers were laminated in the following order in the evaluation cell to prepare a test laminate. As an electrolyte, the composite electrolyte of Example 2B and Comparative Example 1A (only LLZT) were used. Note that the area perpendicular to the voltage application direction in the cell was 0.50 cm² for a Li electrode and 0.79 cm² for the electrolyte.

### (Lithium/Composite Electrolyte/Lithium)

Arbitrary current densities of X mA/cm² and −X mA/cm² were alternately applied to the evaluation cell (lithium-lithium symmetric cell) for 1 hour using an electrochemical measurement system (VSP manufactured by BioLogic) (the value of X will be described later).

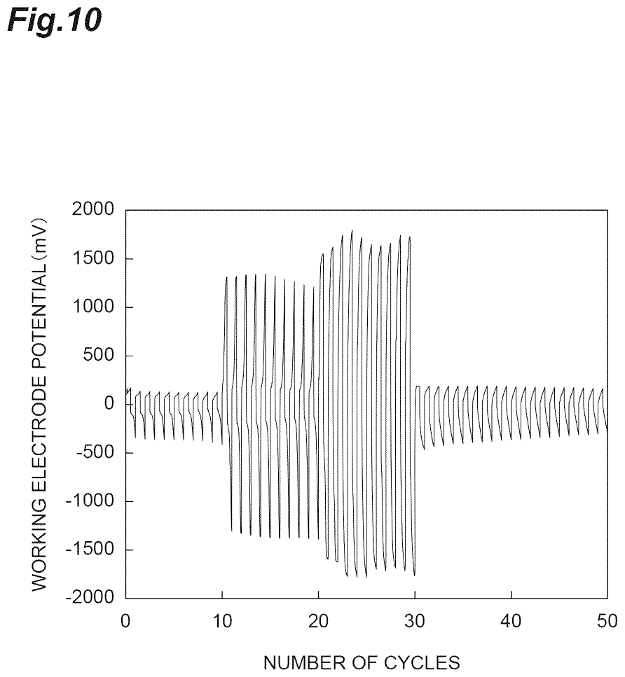

FIG. 10 is a diagram illustrating results of a cycle test for a lithium-lithium symmetric cell using the composite electrolyte of Example 2B as the electrolyte. As illustrated in FIG. 10, when lithium deposition and dissolution was repeated 10 cycles at a current density of 20 μA/cm², 10 cycles at 50 μA/cm², 10 cycles at 100 μA/cm², and then 20 cycles at 20 μA/cm² again, it was confirmed that the stable cycle was possible.

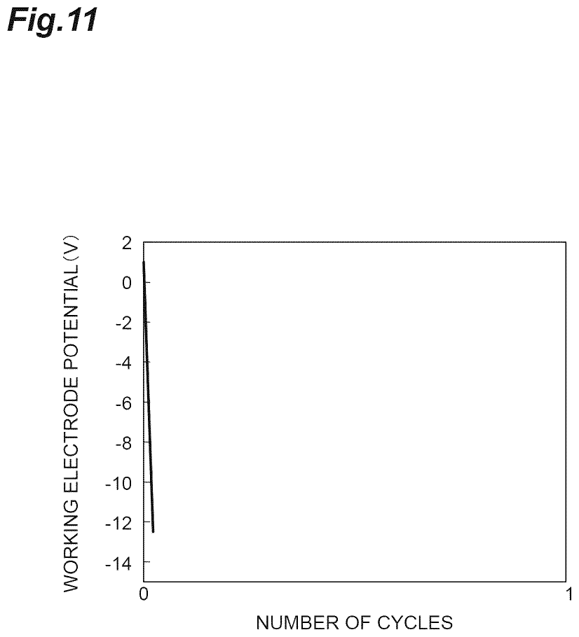

FIG. 11 is of a current density of 100 μA/cm² for a lithium-lithium cell using Comparative Example 1A (only LLZT) as the electrolyte. In the case of Comparative Example 1A, charging and discharging could not be performed.

1. A composite electrolyte comprising an inorganic solid electrolyte and a plastic ionic crystal containing an alkali metal ion.

2. The composite electrolyte according to claim 1, wherein anions contained in the plastic ionic crystal include an anion having a —SO₂— group.

3. The composite electrolyte according to claim 1, wherein at least one of anions contained in the plastic ionic crystal has a —SO₂NSO₂— group or a —SO₃— group.

4. The composite electrolyte according to claim 1, wherein the plastic ionic crystal contains at least one of (FSO₂)₂N⁻ and (CF₃SO₂)₂N⁻.

5. The composite electrolyte according to claim 1, further comprising an organic cation,
wherein at least one of anions contained in the plastic ionic crystal has a —SO₂NSO₂— group, and
at least one of following conditions (1) and (2) is satisfied for a Raman spectrum measured at 25° C.:
(1) a Raman shift of a peak corresponding to S—N—S deformation vibration of the anion interacting with the organic cation measured for the composite electrolyte is a higher wavenumber than a Raman shift of a peak corresponding to S—N—S deformation vibration of the anion measured for the plastic ionic crystal which is a salt of the organic cation and the anion contained in the composite electrolyte; and
(2) a Raman shift of a peak corresponding to S—N—S deformation vibration of the anion interacting with the alkali metal ion measured for the composite electrolyte is a higher wavenumber than a Raman shift of a peak corresponding to S—N—S deformation vibration of the anion measured for a salt of the alkali metal ion and the anion contained in the composite electrolyte.

6. The composite electrolyte according to claim 1, further comprising an organic cation,
wherein at least one of anions contained in the plastic ionic crystal has a —SO2NSO2- group, and
for a Raman spectrum measured at 25° C., a ratio (Li+/Org+) of an area of a peak corresponding to S—N—S deformation vibration of an anion interacting with the alkali metal ion and an anion interacting with the organic cation among the anions measured for the composite electrolyte is lower than a ratio (Li+/Org+) of the area measured for the plastic ionic crystal which is a salt of the organic cation and the anion contained in the composite electrolyte.

7. The composite electrolyte according to claim 1, wherein the inorganic solid electrolyte contains at least one selected from a group consisting of an oxide-based inorganic solid electrolyte, a hydride-based solid electrolyte, and a halide-based solid electrolyte.

8. The composite electrolyte according to claim 1, wherein the inorganic solid electrolyte contains an oxide-based inorganic solid electrolyte.

9. The composite electrolyte according to claim 8, wherein at least one diffraction peak derived from the oxide-based inorganic solid electrolyte and having a half-value width of 0.18° or less is observed in a range in which 2θ is 20° or less in an X-ray diffraction chart obtained by measuring the composite electrolyte using a CuKα ray at 25° C.

10. The composite electrolyte according to claim 8, wherein
the oxide-based inorganic solid electrolyte includes an acid-treated oxide-based inorganic solid electrolyte, and
at least one half-value width of a diffraction peak in a range in which 2θ is 20° or less, observed for the acid-treated oxide-based inorganic solid electrolyte, is 0.8 times or less a half-value width of a diffraction peak derived from a crystal plane identical to a crystal plane of the diffraction peak and observed for the oxide-based inorganic solid electrolyte before an acid treatment in an X-ray diffraction chart obtained by measurement using a CuKα ray at 25° C. before and after the acid treatment is performed.

11. The composite electrolyte according to claim 8, wherein, as the oxide-based inorganic solid electrolyte, an oxide-based inorganic solid electrolyte in which at least one diffraction peak having a half-value width of 0.18° or less is observed in a range in which 2θ is 20° or less in an X-ray diffraction chart obtained by measuring the oxide-based inorganic solid electrolyte at 25° C. using a CuKα ray is mixed.

12. An electrolyte for a battery, comprising the composite electrolyte according to claim 1.

13. A battery comprising the electrolyte for a battery according to claim 12.

14. The composite electrolyte according to claim 2, further comprising an organic cation,
wherein at least one of anions contained in the plastic ionic crystal has a —SO2NSO2- group, and
at least one of following conditions (1) and (2) is satisfied for a Raman spectrum measured at 25° C.:
(1) a Raman shift of a peak corresponding to S—N—S deformation vibration of the anion interacting with the organic cation measured for the composite electrolyte is a higher wavenumber than a Raman shift of a peak corresponding to S—N—S deformation vibration of the anion measured for the plastic ionic crystal which is a salt of the organic cation and the anion contained in the composite electrolyte; and
(2) a Raman shift of a peak corresponding to S—N—S deformation vibration of the anion interacting with the alkali metal ion measured for the composite electrolyte is a higher wavenumber than a Raman shift of a peak corresponding to S—N—S deformation vibration of the anion measured for a salt of the alkali metal ion and the anion contained in the composite electrolyte.

15. The composite electrolyte according to claim 2, further comprising an organic cation,
wherein at least one of anions contained in the plastic ionic crystal has a —SO2NSO2- group, and
for a Raman spectrum measured at 25° C., a ratio (Li+/Org+) of an area of a peak corresponding to S—N—S deformation vibration of an anion interacting with the alkali metal ion and an anion interacting with the organic cation among the anions measured for the composite electrolyte is lower than a ratio (Li+/Org+) of the area measured for the plastic ionic crystal which is a salt of the organic cation and the anion contained in the composite electrolyte.

16. The composite electrolyte according to claim 2, wherein the inorganic solid electrolyte contains at least one selected from a group consisting of an oxide-based inorganic solid electrolyte, a hydride-based solid electrolyte, and a halide-based solid electrolyte.

17. The composite electrolyte according to claim 2, wherein the inorganic solid electrolyte contains an oxide-based inorganic solid electrolyte.
